(19) United States
(12) Patent Application Publication
(10) Pub. No.: US 2005/0106361 A1
(43) Pub. Date: May 19, 2005

(54) Floor protective device for motorcycles and the like

(76) Inventor: Tom Clark, Signal Hill, CA (US)

Correspondence Address: Tom Clark, Suite 202, 6 South Main Street, Washington, PA, 15301, US

(21) Appl. No.: 10/970,345

(22) Filed: Oct. 21, 2004

Related U.S. Application Data
(60) Provisional application No. 60/513,715, filed on Oct. 24, 2003.

(51) Int. Cl. B32B 3/00

(52) U.S. Cl. 428/192; 428/122

(57) ABSTRACT

The present invention comprises a generally rectangular base with two longitudinal containment lips and two semi-arcuate lips on the front and rear for the containment and display of motorcycles or similar vehicles. The apparatus is uniquely suited to hold and display motorcycles or similar vehicles in an aesthetically pleasing manner while also containing and fluid leaks or spillage that may occur during the storage or display.

### RELATED APPLICATIONS

This application claims the benefit of U.S. Provisional Application No. 60/513,715 filed on Oct. 24, 2003.

### BACKGROUND OF THE INVENTION

1. Field of the Invention

The present invention relates generally to a floor covering device for motorcycles, off-road sport vehicles and the like, and more particularly to a tray with raised sides for said vehicles to sit upon for storage, to contain fluid spills, or for display purposes.

2. Description of the Related Art

Countless Americans enjoy riding motorcycles. The feeling of freedom and pure exhilaration while cruising the countryside with the wind in your hair is a leisure time activity for many. Many others do it out of necessity in the time of rising gas prices. Whatever the reason one has for riding a motorcycle, they do require maintenance. Any spilled liquid such as oil or gas is difficult to clean up from surfaces such as concrete and asphalt. Finally, those with prized motorcycles that are worthy of being displayed at a show or museum are constantly looking for an edge that will set their bike apart from others on display. Accordingly, there exists a need for a means by which motorcycles can be stored, worked on, and displayed in a manner without the disadvantages as described above. The development of the present invention fulfills this need.

A search of the prior art did not disclose any patents already issued that dealt directly with the aforementioned problems; however, the following table lists patents that were considered related:

| U.S. Pat. No. | Inventor | Issue Date |
|---|---|---|
| 6,234,452 | Johnson | May 22, 2001 |
| 6,120,876 | Walton | Sep. 19, 2000 |
| 6,095,499 | Johnson | Aug. 1, 2000 |
| 6,062,162 | Dean | May 16, 2000 |
| 5,979,878 | Blankenship | Nov. 9, 1999 |
| 5,927,689 | Johnson | Jul. 27, 1999 |
| 5,639,067 | Johnson | Jun. 17, 1997 |

For example, in U.S. Pat. No. 6,234,452, No. 6,095,499, No. 5,927,689 and No. 5,639,067, all issued in the name of Johnson, discloses a hand-operable motorcycle stand. The devices described by Johnson involve the use of a compact, hand-operable stand merely for aiding in the raising and lowering the motorcycle. The patents issued to Johnson do not take into account the primary concern of protecting floor surfaces. Also, the Johnson patents involve many moving parts and are mainly concerned with the servicing of the motorcycle and not with displaying the motorcycle in a visually appealing manner, as is the case with the present invention. U.S. Pat. No. 5,979,878 issued in the name of Blankenship, is similar in scope to the Johnson patents, but includes pull cables, in that it involves the means to raise and lower the motorcycle for servicing, but doesn't have any of the features or advantages of the present invention.

Several patents have been issued describing devices for protecting the interior floor of a garage or other automobile storage or service facility. Specifically, U.S. Pat. No. 6,120,876 issued in the name of Walton has as a feature the benefit of a protector for the floor of a garage or the like that is manufactured out of a unitary material of construction and is designed to collect anything that may fall from a vehicle, including rain, snow, or slush. However, the Walton patent is concerned with protecting the floor of the garage specifically from liquid runoff from a 4-wheeled automobile and is not suitable for the aesthetic display of a 2-wheeled vehicle. U.S. Pat. No. 6,062,162, issued to Dean, is essentially a garage parking aid. The Dean device includes an anti-skid mat with means to contain any fluid spillage and a marker to aid in parking a vehicle into a garage. Again, the present invention differs from the prior art in that it is concerned with the visually appealing means of storing and displaying a motorcycle.

Consequently, a need has been felt for providing a device that can store and display a motorcycle, as well as other off-road sport vehicles, in an aesthetic manner and at the same time protect the floor of the facility in which it resides.

### SUMMARY OF THE INVENTION

It is therefore an object of the present invention to provide a visually appealing means to display motorcycles or the like.

It is therefore another object of the present invention to provide means for protecting the ground or floor of a storage facility, garage, driveways, and similar surfaces from leaking fluids associated with motorcycles or the like.

It is another object of the present invention to make any cleaning of leaking fluids quick and easy.

It is yet another object of the present invention to provide a secure means to retain the wheels of a motorcycle or the like.

Briefly described according to the preferred embodiment of the present invention, an apparatus is provided to protect the floor of a facility that stores or displays motorcycles or the like in an aesthetically pleasing manner. It is of a generally large, flat, rectangular construction that allows one to drive a motorcycle or similar vehicle onto it. Two of the four sides have a lip designed to contain any spilled materials. The other two sides consist of a raised roll-over lip to facilitate one to drive the motorcycle or like vehicle onto the device and has an added feature of preventing the vehicle from rolling off. The roll-over lip has an added benefit of containing spilled fluids. In a preferred embodiment of the present invention, the material of construction is a highly polished, ⅛″-thick unitary piece of aluminum diamond plate. In order to best utilize the present invention, the user simply lays it flat upon the surface to be protected. Next, the motorcycle or similar vehicle is driven or rolled onto the present invention and placed in a parked position. The polished surface of the preferred embodiment presents a visually pleasing display and the diamond plated aluminum construction, in conjunction with the raised lips, provide means to retain the vehicle on the device. The raised lips and roll-over lips on the circumference of the device also help to contain spilled fluids. The present invention is portable and can be used for any number of vehicles deigned worthy of display by the user.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the floor protective device for motorcycles and the like 10, according to a preferred embodiment of the present invention;

FIG. 2 is a top view of the floor protective device for motorcycles and the like 10, according to a preferred embodiment of the present invention;

FIG. 3 is a bottom view of the floor protective device for motorcycles and the like 10, according to a preferred embodiment of the present invention;

FIG. 4 is a left-side view of the floor protective device for motorcycles and the like 10, according to a preferred embodiment of the present invention; and

FIG. 5 is an frontal view of the floor protective device for motorcycles and the like 10, according to a preferred embodiment of the present invention.

### DESCRIPTIVE KEY

10 floor protective device

15 polished diamond-plate surface

16 front roll-over lip

17 rear roll-over lip

18 left-side spill containment lip

19 right-side spill containment lip

### DESCRIPTION OF THE PREFERRED EMBODIMENTS

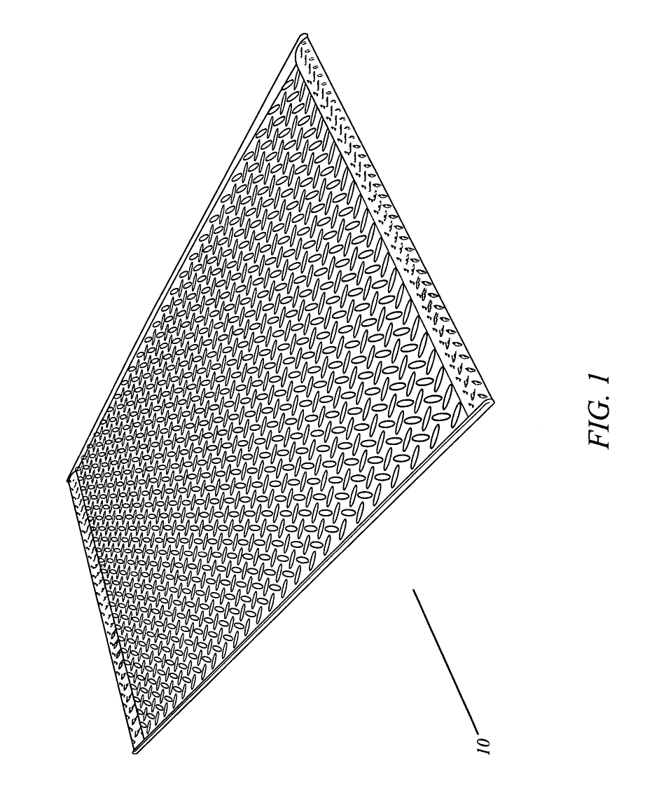

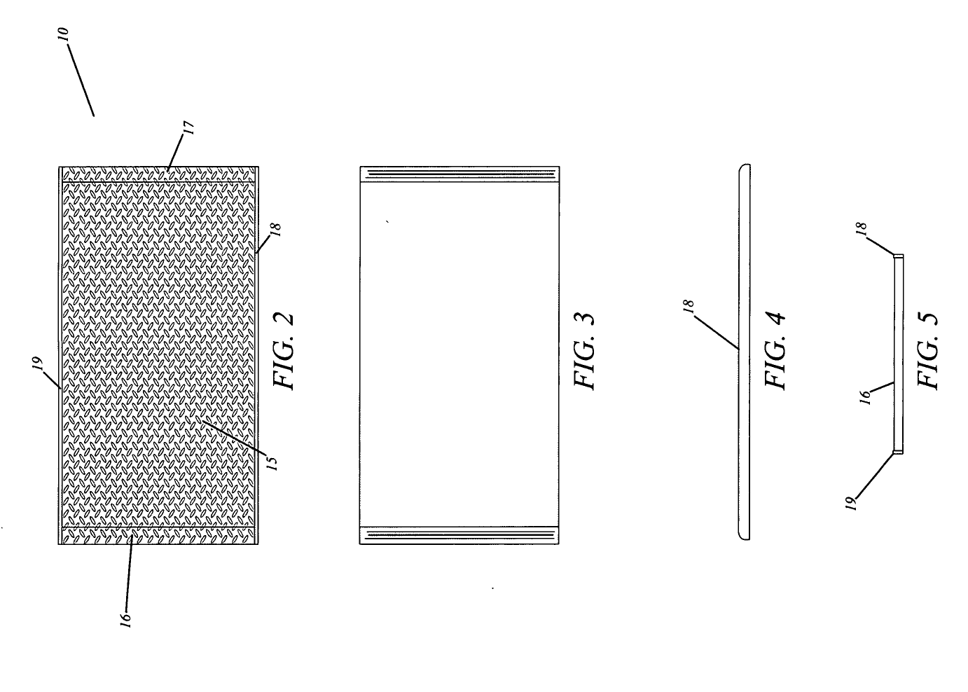

The best mode for carrying out the invention is presented in terms of its preferred embodiment, herein depicted within the FIGS. 1 through 5.

1. Detailed Description of the Figures

Referring now to FIG. 1-5, a perspective view of the floor protective device 10 is disclosed in accordance with the preferred embodiment of the present invention, for protecting the floor of a storage facility or like from motorcycles or similar vehicles. The device aids in containing any fluid spills or leaks that are so often associated with storing and displaying vehicles for any amount of time. Any unsightly build-up of oil or antifreeze on the ground of the storage or display facility can become a safety hazard if not contained or cleaned properly. The floor protective device 10 also has as an added feature to display said vehicle in an aesthetically pleasing manner. By placing the floor protective device 10 directly underneath the vehicle, the above problems are eliminated.

The Floor Protection Device for Motorcycles and the Like 10 is comprised of a unitary sheet of polished ⅛″-thick diamond plate aluminum with four sidewalls forming an open upper volume to support the motorcycle or similar vehicle and to contain fluid spills. The aluminum sheet is generally rectangular in shape, and the surface of the plate has a preformed and polished diamond-plate stamped arrangement 15. This particular type of plate provides the necessary tread to retain the vehicle's wheels without the extra step for chocking the wheels in order to ensure that the vehicle will not move off the floor protective device 10. Also, the polished surface renders a mirrored look that provides an extremely pleasing visual experience.

During manufacturing, the sheet is bent perpendicularly in the vertical plane with respect to the polished diamond-plate surface 15 along the long sides of the floor protective device 10 into the left-side containment lip 18 and right-side containment lip 19 at a height sufficient for the containment of spillages. Also, the front and rear portions of the floor protective device 10 are rolled in the vertical position, thus fashioning the front roll-over lip 16 and rear roll-over lip 17, respectively. These roll-over lips are rolled in a semi-arcuate shape to a height matching that of the left-side containment lip 18 and right-side containment lip 19. As seen in FIG. 5, at the points of contact between the front roll-over lip 16 and left-side containment lip 18 and right-side containment lip 19 there exists means to effect a permanent contact point in order to produce a seal for the ultimate means of containing any spills from the vehicle on display. The permanent contact points may be achieved via adhesive or heat-bonding means. Similarly, the rear roll-over lip 17 is affixed to the left-side containment lip 18 and right-side containment lip 19 in a similar fashion. After the points of contact have been permanently sealed together, the left-side containment lip 18 and right-side containment lip 19 is rounded off at the same semi-arcuate radius as the front roll-over lip 16 and rear roll-over lip 17 to prevent any sharp edges protruding outward, thereby, creating another safety hazard (see FIG. 4).

2. Operation of the Preferred Embodiment

To use the invention, the user simply lays the apparatus flat upon the surface to be protected, such as garages, driveways, showroom floors, or any other storage and/or display facility. Next, the motorcycle, off-road sports or similar vehicle is driven or rolled onto the device. The vehicle, which rests on top of the floor protective device, is then stored or displayed at the length of time as determined by the user. When storing or displaying the vehicle has been completed, the user merely rolls or drives the vehicle off the floor protective device.

The foregoing description is included to illustrate the operation of the preferred embodiment and is not meant to limit the scope of the invention. The scope of the invention is to be limited only by the following claims.

1. An apparatus for placement beneath a motorcycle or other small off-road sport vehicle for the collection of fluid drips and spillage.

2. The apparatus is of a general rectangular-shaped base sufficient in size to accommodate a vehicle as described in claim 1

3. The apparatus has left-side and right-side containment lips formed from the base and extending perpendicularly from the surface of the base described in claim 2 and sufficient in height to collect and contain fluids.

4. The apparatus has front and rear roll-over lips that are semi-arcuate in shape formed from the base described in claim 2 to allow wheels to easily roll over and be positioned within the containment area.

5. Referring to claim 3, the left-side and right-side containment lips are sealed to the front and rear roll-over lips to form a sealed containment area.

6. Referring to claim 4, the front and rear roll-over lips maintain a vehicle from inadvertently leaving said containment area

7. Referring to claim 4, the front and rear roll-over lips are of an equal height to left-side and right-side containment lips.

8. Wherein said left-side containment lip, and said right-side containment lip, and said front roll-over lip, and said rear roll-over lip, and said base form an open upper volume where fluid drips and spillages may accumulate and eventually be properly discarded.

9. The apparatus protects the surface of a floor, a driveway, a showroom, or other storage or display facility from damage due to the vehicle or due to any fluid discharge from the vehicle.

10. The apparatus as placed beneath a motorcycle or other small off-road sport vehicle functions as a display platform.
